(19) United States
(12) Patent Application Publication
(10) Pub. No.: US 2018/0178615 A1
(43) Pub. Date: Jun. 28, 2018

(54) INTELLIGENT MULTI-LOOP THERMAL MANAGEMENT SYSTEM FOR AN ELECTRIC VEHICLE

(71) Applicant: Bordrin Motor Corporation, Southfield, MI (US)

(72) Inventors: Yingbo Xia, Shanghai (CN); Zhiwei Zhang, Shanghai (CN); Yunfei Wu, Shanghai (CN); Yonghua Li, Ann Arbor, MI (US)

(21) Appl. No.: 15/687,876

(22) Filed: Aug. 28, 2017

(30) Foreign Application Priority Data
Dec. 27, 2016 (CN) 201611226019.3

(51) Int. Cl. B60H 1/00; B60K 1/02; B60K 11/02; B60K 11/06; B60L 11/18; B60H 1/14; B60H 1/22; B60H 1/32; H01M 10/637; H01M 10/625; H01M 10/6568

(52) U.S. Cl. CPC B60H 1/00271; B60K 2001/005; B60K 11/02; B60K 11/06; B60L 11/1874; B60L 11/1875; B60H 1/00278; B60H 1/143; B60H 1/2221; B60H 1/00885; B60H 1/323; H01M 10/637; H01M 10/625; H01M 10/6568; B60K 1/02

(57) ABSTRACT

An intelligent multi-loop thermal management system for and electric vehicle has components including a battery pack, an electric-drive module, an on-board charger a DC/DC converter, a battery radiator, a battery refrigerator, a motor radiator, an electric water pump, an electric oil pump, an expansion tank, a PTC heater, a heat exchanger, an electric compressor, a condenser, an evaporator, a receiver drier, and a heater core. The system also includes an electric-drive module having a drive motor and a motor control unit. The components are thermally connected to each other by using a pipeline and a four-way valve, a three-way valve, a straight-through valve, and an electronic expansion valve that are disposed in the pipeline, to form a plurality of loops that separately performs thermal management and control the battery pack, the electric-drive module, and a passenger compartment air conditioner.

### PRIORITY CLAIM

This application claims the benefit of priority from Chinese Patent Application No. 201611226019.3 filed Dec. 27, 2016, which is incorporated by reference.

### BACKGROUND

### 1. Field of the Invention

The present invention generally relates to the technical field of electric vehicles, and in particular, to an intelligent multi-loop thermal management system of an electric vehicle.

### 2. Description of Related Art

With growing global concern of environmental pollution and consumption of fossil energy resources, the prospect of electric vehicles has become increasingly bright. The production and sales of electric vehicles have been on a growing trend. Potentially, electric vehicles may completely replace conventional automobiles based on internal combustion engines in the near future. Compared with conventional automobiles, electric vehicles do not produce exhaust emissions and are very environmentally friendly. However, the development of electric vehicles is presently facing some challenges. For example, electric vehicles need a relatively long time for charging their power batteries and have limited range with a fully-charged battery in comparison with fully fueled conventional automobiles. In order to achieve a full-charge range comparable to traditional automobiles, electric vehicles need to run as energy efficiently as possible. Many of the electric vehicles currently available in the market contain thermal management systems that are not energy efficient. For example, an air-conditioning system, a cooling system for the battery-pack, and a cooling system for the electric-drive-module may not be sufficiently linked and operated in a synergetic manner with respect to heat or energy transfers between them. Cooling of a battery pack usually relies excessively on air-conditioning refrigeration or alternatively via a battery radiator added in front of a condenser. This negatively impacts the performance of air conditioning and effectiveness of heat dissipation of the electric-drive module, lower drive efficiency and drivability, increase wind resistance, and reduce overall economical efficiency of the vehicle. When a power battery and a passenger compartment need to be heated, heating usually excessively relies on PTC (positive temperature coefficient) heaters, drawing energy from the power battery and resulting in shorter range for the vehicle.

Chinese Patent CN205768485U discloses an intelligent vehicle thermal management system of an electric vehicle, including a front heat exchanger, a passenger compartment heat exchanger, a television, an electric control system, a drive motor water pump, a four-way reversing valve, a compressor, an electromagnetic valve, two three-way ball valves, an evaporator, a water pump, a battery holder, a heat pipe, and a battery heat exchanger, so that three thermal management systems, i.e., an air conditioning system, a drive motor electric control system, and a battery pack thermal management system of a vehicle fully utilize energy transfer between the three thermal management systems, thereby reducing energy requirements of cooling and heating, ensuring temperature equalization among battery cells, and increasing the full-charge range and service life of the power battery. However, a relatively small quantity of control loops are formed in such a system. Functions of components inside the system that may help further reduce energy consumption for heating and cooling cannot be fully utilized.

### SUMMARY

A thermal management system of an intelligent multi-loop electric vehicle may include: a battery pack, an electric-drive module, an on-board charger, a DC/DC converter, a battery radiator, a battery refrigerator, a motor radiator, an electric water pump, an electric oil pump, an expansion tank, a PTC heater, a heat exchanger, an electric compressor, a condenser, an evaporator, a receiver drier, and a heater core, where the electric-drive module may include a drive motor and a motor control unit, and the components are connected by using a pipeline and a four-way valve, a three-way valve, a straight-through valve, and an electronic expansion valve that are disposed in the pipeline, to form a plurality of loops that separately performs thermal management and control on the battery pack, the electric-drive module, and a passenger compartment air conditioner, the loops including:

a power-battery-pack temperature-equalization internal loop, a power-battery-pack room-temperature-cooling internal loop, a power-battery-pack air-conditioning-refrigeration external loop, a power-battery-pack air-conditioning-refrigeration internal loop, and a power-battery-pack low-temperature-heating internal loop that perform thermal management and control on the battery pack;

a passenger-compartment refrigeration loop, a passenger-compartment heating large circulation loop, and a passenger-compartment heating small circulation loop that perform thermal management and control on the passenger compartment air conditioning; and

an electric-drive-module cooling loop and a drive-motor oil-cooling loop that perform thermal management and control on the electric-drive module.

The power-battery-pack temperature-equalization internal loop may be formed by connecting the battery pack, the four-way valve, the electric water pump, the three-way valve, and the PTC heater in series, and in this case, the PTC heater is not in operation. The power-battery-pack low-temperature-heating internal loop may be formed by connecting the battery pack, the four-way valve, the electric water pump, the three-way valve, and the PTC heater in series, and in this case, the PTC heater is set in operation. The power-battery-pack room-temperature-cooling internal loop may be formed by connecting the battery pack, the four-way valve, the electric water pump, the three-way valve, and the battery radiator in series. The power-battery-pack air-conditioning-refrigeration external loop may be formed by connecting the electric compressor, the condenser, the receiver drier, the electronic expansion valve, and the battery refrigerator in series. The power-battery-pack air-conditioning-refrigeration internal loop may be formed by connecting the battery pack, the four-way valve, the electric water pump, the three-way valve, and the battery refrigerator in series.

The electric-drive-module cooling loop may be formed by connecting the electric water pump, the straight-through valve, the motor control unit, the heat exchanger, the three-way valve, the motor radiator, the four-way valve, and the expansion tank in series. The drive-motor oil-cooling loop may be formed by connecting the drive motor, the heat exchanger, and the electric oil pump in series.

The passenger-compartment refrigeration loop may be formed by connecting the electric compressor, the condenser, the receiver drier, the electronic expansion valve, and the evaporator in series. The passenger-compartment heating large circulation loop may be formed by connecting the electric-drive-module cooling loop, the straight-through valve, and the heater core in series. The passenger-compartment heating small circulation loop may be formed by connecting the heater core, the electric water pump, the straight-through valve, and the PTC heater in series.

The electric water pump, the electric oil pump, the straight-through valve, the three-way valve, the four-way valve, and the electronic expansion valve are connected to a vehicle control unit. The battery pack may be connected in series or in parallel to the electric-drive module by controlling a degree of opening of the four-way valve.

In the thermal management system, temperature sensors are provided inside the battery pack, the drive motor, the motor control unit, the DC/DC converter, and the on-board charger and inside the cooling loops, and the temperature sensors are connected to the vehicle control unit and output measured temperatures to the vehicle control unit.

The DC/DC converter may be connected in series to the straight-through valve and may be connected in parallel to the battery pack, and the on-board charger may be connected in parallel to the electric-drive module.

Further, the drive motor may include a first drive motor and a second drive motor, the motor control unit may include a first motor control unit and a second motor control unit, the electric water pump may include a first electric water pump, a second electric water pump, a third electric water pump, and a fourth electric water pump, the electric oil pump may include a first electric oil pump and a second electric oil pump, the PTC heater may include a first PTC heater and a second PTC heater, the heat exchanger may include a first heat exchanger and a second heat exchanger, the electronic expansion valve may include a first electronic expansion valve and a second electronic expansion valve, the three-way valve may include a first three-way valve, a second three-way valve, a third three-way valve, and a fourth three-way valve, and the straight-through valve may include a first straight-through valve, a second straight-through valve, a third straight-through valve, and a fourth straight-through valve. The first electric water pump, the first motor control unit, and the first heat exchanger are connected in series and are connected in parallel to the second electric water pump, the second motor control unit, and the second heat exchanger that are connected in series.

In the thermal management system, an electric fan that assists heat dissipation and connected to the vehicle control unit may be provided beside the motor radiator and the battery radiator, the electric fan may include a first electric fan and a second electric fan, and in the thermal management system, an electric blower connected to the vehicle control unit may be provided beside the evaporator. The radiator and the electric fan are mounted at relatively flexible positions. The radiator and the electric fan may be arranged according to characteristics of a vehicle body structure of an electric vehicle, and may be arranged near the front of the vehicle, disposed at the rear of the vehicle, or disposed at any other position of the vehicle. One or more electric fans may be disposed according to need.

In the thermal management system, the electric water pump, the electric oil pump, the electric fan, the electric blower, the straight-through valve, the three-way valve, the four-way valve, and the electronic expansion valve are all connected to the vehicle control unit. In the thermal management system, temperature sensors are provided inside the battery pack, the drive motor, the motor control unit, the DC/DC converter, and the on-board charger and inside the cooling loops, and the temperature sensors are connected to the vehicle control unit and output collected temperature information to the vehicle control unit. The vehicle control unit makes a decision according to temperature signals, controls operation of the electric water pump, the electric oil pump, the electric fan, and the electric blower and opening and closing of the four-way valves, the straight-through valves, the three-way valves, and the electronic expansion valves, regulates heat exchange of the system in a timely and effective manner, and controls degrees of opening of the three-way valves, the four-way valves, the straight-through valves, and the electronic expansion valves, to form the thermal management and control loops that satisfy different cooling or heating requirements.

When the temperature of the battery pack is within a reasonable temperature range (for a lithium ion battery, the reasonable range may be between 0° C. and 40° C.). However, when a temperature difference between battery cells is excessively large and exceeds a reasonable temperature difference value (when the maximum temperature difference between cells is less than 5° C., it is usually considered reasonable), temperature equalization needs to be performed on the battery pack, and the power-battery-pack temperature-equalization internal loop can effectively reduce temperature differences between cells of the battery pack.

When the temperature of the battery pack is relatively high (e.g., higher than 40° C.), the battery pack needs to be cooled, and the power-battery-pack room-temperature-cooling internal loop can effectively reduce the temperature of the battery pack.

When the temperature of outside air is excessively high or the heating power of the battery pack is excessively high, the power-battery-pack room-temperature-cooling internal loop cannot satisfy a heat dissipation requirement of the battery pack. In this case, the battery pack needs to be cooled by means of air-conditioning refrigeration, and the power-battery-pack air-conditioning-refrigeration external loop and the power-battery-pack air-conditioning-refrigeration internal loop can rapidly lower the temperature of the battery pack.

When the electric vehicle is parked and being charged, if the temperature of the battery pack is relatively low (e.g., below 0° C.), the battery pack 38 may not be rapidly charged. Therefore, the battery pack 38 may need to be preheated. The power-battery-pack low-temperature-heating internal loop can satisfy a heating requirement of the battery pack in a low temperature situation.

When the electric vehicle is in normal operation, an electric-drive module component (a high-power component such as the drive motor and the motor control unit) of the electric vehicle usually needs to be cooled, and the electric-drive-module cooling loop may cool the electric-drive module component. For a two-wheel-drive electric vehicle, an electric-drive module of the electric vehicle may include only one drive motor, one motor control unit, and an on-board charger. For a four-wheel-drive electric vehicle, an electric-drive module of the electric vehicle may include components such as two groups of drive motors and motor control units that are connected in parallel. Electrically insulating but thermally conductive oil in the drive-motor oil-cooling loop may enter the drive motor, directly cools a rotor of the motor.

A battery pack loop and a drive loop may form a parallel loop or a series loop by means of switching using the four-way valve. When a port B and a port C of the four-way valve are connected, an internal circulation loop of the battery pack may be formed. When a port A and a port D are connected, a control loop may be formed externally. When A and B are connected and C and D are connected, the battery pack and the electric-drive module are connected in series and may perform heat exchange with each other.

When the temperature of a coolant at an outlet of the motor radiator is greater than a required upper limit of coolant temperature within a power-battery-pack cooling loop, the electric-drive-module cooling loop and the power-battery-pack cooling loop are connected in parallel, thereby dividing the coolant, to protect the battery pack.

When the motor and the motor control unit generate a small amount of heat and do not need to be cooled, the coolant no longer flows through cooling the pipelines inside the motor and the motor control unit, but instead, flows through the on-board charger and the motor radiator to be connected in series to a room-temperature-cooling internal loop of the battery pack, and may be configured to cool the battery pack and the DC/DC converter, so that energy consumption can be reduced.

When the motor and the motor control unit generate an excessively large amount of heat, the temperature of the coolant at the outlet of the motor radiator may be higher than required upper limits of coolant temperatures at the motor control unit and the motor. In this case, the motor and the motor control unit may be cooled by connecting the power-battery-pack air-conditioning-refrigeration internal loop and the electric-drive-module cooling loop in series. In this case, cooling requirements of the electric vehicle at a maximum speed and in other extreme working conditions can be satisfied.

When the battery pack is in a low temperature state and needs to be heated, the electric-drive-module cooling loop may be connected in series to the power-battery-pack low-temperature-heating internal loop, and the battery pack is heated by using waste heat of the motor and the motor control unit. In this way, energy consumption needed for heating the power-battery-pack can be reduced.

When the electric vehicle is being charged under alternating-current, if the battery pack or the DC/DC converter and the on-board charger both need to be cooled, the power-battery-pack cooling loop may be connected in series to the electric-drive-module cooling loop, so that the power-battery-pack cooling loop and the electric-drive-module cooling loop share the battery radiator and the second electric fan, thereby facilitating heat transfer between the two loops and reducing energy consumption.

When the temperature of a passenger compartment needs to be regulated, thermal management and control is performed on the passenger compartment air conditioner by using the passenger-compartment refrigeration loop, the passenger-compartment heating large circulation loop, and the passenger-compartment heating small circulation loop, providing comfort in the passenger compartment. When the temperature of the passenger compartment is relatively high, cooling is performed by using the passenger-compartment refrigeration loop. When the temperature of the passenger compartment is relatively low, heating is performed by using the passenger-compartment heating large circulation loop and the passenger-compartment heating small circulation loop. Heat is supplied by preferentially using the waste heat of the motor and the motor control unit. When the amount of the waste heat of the motor and the motor control unit is insufficient for the heating of the passenger compartment, heat may be supplied by using the passenger-compartment heating small circulation loop. The passenger-compartment heating large circulation loop and the passenger-compartment heating small circulation loop may function at the same time.

Benefits of the present invention are: The thermal management system forms a plurality of loops capable of automatic regulation by configuring a plurality of three-way valves, straight-through valves, four-way valves, and electronic expansion valve. Loops satisfying different cooling or heating requirements may be formed by regulating the degrees of opening of the electronic expansion valve, the four-way valves, the three-way valve, and the straight-through valve. These loops may be selectively opened or closed according to characteristics and working states of the battery pack, the electric-drive module, and the passenger compartment air conditioner of the electric vehicle. In this way, heat equalization of the electric vehicle is maintained, and efficient operation of the electric vehicle is improved.

The system provides energy saving, and the loops of the battery pack, the electric-drive module, and the passenger compartment air conditioner are linked to each other when needed and are connected in series or in parallel by means of opening or closing various valves. When the battery pack needs to be cooled, cooling no longer overly depends on air-conditioning refrigeration. In addition to the battery radiator and the motor radiator, the battery refrigerator can further be used to assist heat dissipation. This reduces negative impact on air conditioning performance and a heat dissipation efficiency of the electric-drive module. When the passenger compartment needs to be heated and the battery pack needs to be heated, waste heat of the electric-drive module component can be fully utilized, to reduce power consumption, increase the range of an electric vehicle, and improve the economic efficiency of the vehicle.

Further examples, features, and advantages of this invention will become readily apparent to persons of ordinary skill in the art in the following description, with reference to the drawings and claims.

### BRIEF DESCRIPTION OF THE DRAWINGS

FIG. 1 illustrates a schematic structural diagram of a thermal management system according to the present invention;

FIG. 2 illustrates a schematic structural diagram of a power-battery-pack temperature-equalization internal loop;

FIG. 3 is a schematic structural diagram of a power-battery-pack room-temperature-cooling internal loop;

FIG. 4 illustrates a schematic structural diagram of a power-battery-pack air-conditioning-refrigeration external loop and a power-battery-pack air-conditioning-refrigeration internal loop;

FIG. 5 illustrates a schematic structural diagram of a power-battery-pack low-temperature-heating internal loop;

FIG. 6 illustrates a schematic structural diagram of an oil-cooling loop for a front drive motor;

FIG. 7 illustrates a schematic structural diagram of an oil-cooling loop for a rear drive motor;

FIG. 8 illustrates a schematic structural diagram of an electric-drive-module cooling loop of a four-wheel-drive electric vehicle;

FIG. 9 illustrates a schematic structural diagram of an electric-drive-module cooling loop of a two-wheel-drive electric vehicle;

FIG. 10 illustrates a schematic structural diagram of an electric-drive-module cooling loop when the front drive motor is in operation;

FIG. 11 illustrates a schematic structural diagram of an electric-drive-module cooling loop when the rear drive motor is in operation;

FIG. 12 illustrates a schematic structural diagram of an electric-drive-module cooling loop when drive motors of a four-wheel-drive electric vehicle operate at the same time;

FIG. 13 illustrates a schematic structural diagram of an electric-drive-module cooling loop in an alternating-current charging condition;

FIG. 14 illustrates a schematic structural diagram of a series loop I of a battery pack and an electric-drive module;

FIG. 15 illustrates a schematic structural diagram of a series loop II of a battery pack and an electric-drive module;

FIG. 16 illustrates a schematic structural diagram of a series loop III of a battery pack and an electric-drive module;

FIG. 17 illustrates a schematic structural diagram of a series loop IV of a battery pack and an electric-drive module;

FIG. 18 illustrates a schematic structural diagram of a series loop V of a battery pack and an electric-drive module;

FIG. 19 illustrates a schematic structural diagram of a series loop VI of a battery pack and an electric-drive module;

FIG. 20 illustrates a schematic structural diagram of a series loop VII of a battery pack and an electric-drive module;

FIG. 21 illustrates a schematic structural diagram of a passenger-compartment air-conditioning-refrigeration loop;

FIG. 22 illustrates a schematic structural diagram of a large circulation loop I for heating of a passenger-compartment;

FIG. 23 illustrates a schematic structural diagram of a large circulation loop II for heating of a passenger-compartment;

FIG. 24 illustrates a schematic structural diagram of a small circulation loop for heating of a passenger-compartment;

FIG. 25 illustrates a schematic structural diagram in which large circulation and small circulation coexist for heating of a passenger-compartment;

FIG. 26 illustrates a schematic structural diagram of a series loop I of a passenger-compartment heating loop and a battery pack;

FIG. 27 illustrates a schematic structural diagram of a series loop II of a passenger-compartment heating loop and a battery pack;

FIG. 28 illustrates a schematic structural diagram of a series loop III of a passenger-compartment heating loop and a battery pack; and

FIG. 29 illustrates a schematic structural diagram of a series loop IV of a passenger-compartment heating loop and a battery pack.

### DESCRIPTION

The present invention is described below in detail with reference to the accompanying drawings and specific examples.

### Example 1

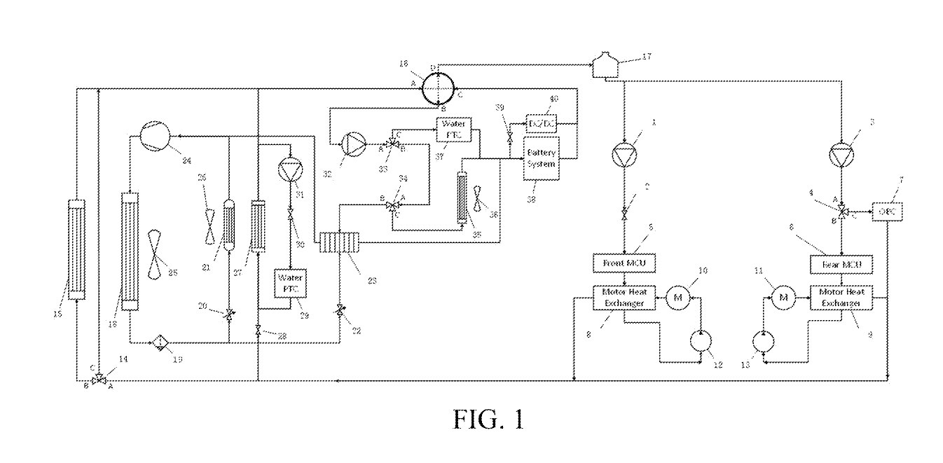

Referring to FIG. 1, a thermal management system of an intelligent multi-loop electric vehicle may include: a battery pack 38, drive motors, motor control units, an on-board charger 7, a DC/DC converter 40, a battery radiator 35, a battery refrigerator 23, a motor radiator 15, electric water pumps, electric oil pumps, an expansion tank 17, a PTC heater, heat exchangers, an electric compressor 24, a condenser 18, an evaporator 21, a receiver drier 19, a heater core 27, a four-way valve 16, three-way valves, straight-through valves, and electronic expansion valves.

In this example, there are two drive motors, e.g., a first drive motor 10 and a second drive motor 11. There are correspondingly two motor control units, e.g., a first motor control unit 5 and a second motor control unit 6. There are four electric water pumps, e.g., a first electric water pump 1, a second electric water pump 3, a third electric water pump 31, and a fourth electric water pump 32. There are two electric oil pumps, e.g., a first electric oil pump 12 and a second electric oil pump 13. There are two PTC heaters, e.g., a first PTC heater 29 and a second PTC heater 37. There are two heat exchangers, e.g., a first heat exchanger 8 and a second heat exchanger 9. There are two electronic expansion valves, e.g., a first electronic expansion valve 20 and a second electronic expansion valve 22. There are four three-way valves, e.g., a first three-way valve 4, a second three-way valve 14, a third three-way valve 33, and a fourth three-way valve 34. There are four straight-through valves, e.g., a first straight-through valve 2, a second straight-through valve 28, a third straight-through valve 30, and a fourth straight-through valve 39. Electric fans for assisting heat dissipation is disposed beside the motor radiator 15 and the battery radiator 35 (a first electric fan 25, a second electric fan 36), and an electric blower 26 is disposed beside the evaporator 21.

In this exemplary system, the electric water pump, the electric oil pump, the electric fan, the electric blower, the straight-through valve, the three-way valve, the four-way valve, and the electronic expansion valve are all connected to a vehicle control unit. In the thermal management system, temperature sensors are provided inside the battery pack, the drive motor, the motor control unit, the DC/DC converter, the on-board charger, and various cooling loops. The temperature sensors are connected to the vehicle control unit and output collected temperature information to the vehicle control unit. The vehicle control unit makes operating decisions according to temperature signals for controlling on and off of the electric water pumps, the electric oil pumps, the electric fans, and the electric blower, for opening and closing, to controllable degrees, of the four-way valve, the straight-through valves, the three-way valves, and the electronic expansion valves, for regulating heat exchange of the system in a timely and effective manner, and for forming thermal management and control loops that satisfy different cooling or heating requirements. The control loops include:

a power-battery-pack temperature-equalization internal loop, a power-battery-pack room-temperature-cooling internal loop, a power-battery-pack air-conditioning-refrigeration external loop, a power-battery-pack air-conditioning-refrigeration internal loop, and a power-battery-pack low-temperature-heating internal loop that collectively perform thermal management and control on the battery pack;

a passenger-compartment refrigeration loop, a passenger-compartment heating large circulation loop, and a passenger-compartment heating small circulation loop that collectively perform thermal management and control on a passenger compartment air conditioner; and

an electric-drive-module cooling loop and a drive-motor oil-cooling loop that collectively perform thermal management and control on an electric-drive module.

### Example 2

When an electric vehicle is running, the temperature of a battery pack 38 needs to be maintained within a proper temperature range. For a lithium ion battery, it is usually considered that when the temperature of the lithium ion battery is between 0° C. and 40° C., the temperature is within a reasonable range, and is neither excessively high nor excessively low. When the temperature of the battery pack 38 is within the reasonable range but a temperature difference between cells is excessively large and exceeds a reasonable temperature difference (it is usually considered that a temperature difference between cells of less than 5° C. is reasonable), temperature equalization needs to be performed on the battery pack 38.

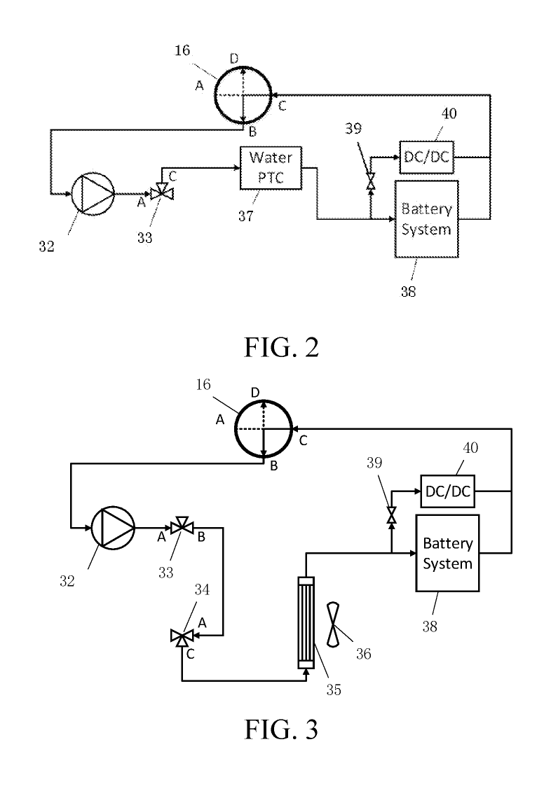

Referring to FIG. 2, a coolant is driven by the fourth electric water pump 32, first flows to an inlet A of the third three-way valve 33 and then flows out from an outlet C, then flows through the second PTC heater 37 (in this case, the second PTC heater 37 is not in operation), then flows to a cooling pipeline inside the battery pack 38, the fourth straight-through valve 39, and the DC/DC converter (the DC/DC converter 40 is connected in parallel to the cooling pipeline of the battery pack 38; when the DC/DC converter 40 does not need to be cooled, the fourth straight-through valve 39 is closed), then flows to a port C of the four-way valve 16 and then flows out from a port B, and eventually returns to the fourth electric water pump 32. In this way, a power-battery-pack temperature-equalization internal loop is formed and can effectively reduce temperature differences between cells of the battery pack 38.

Referring to FIG. 3, when the temperature of the battery pack 38 is relatively high (for a lithium ion battery, when the temperature of the lithium ion battery is higher than 40° C., the temperature is considered relatively high), the battery pack 38 needs to be cooled. The coolant first flows to the fourth electric water pump 32, then flows to the inlet A of the third three-way valve 33 and then flows out from an outlet B, then flows through the inlet A and the outlet C of the fourth three-way valve 34, and then flows to the battery radiator 35. Heat in the coolant is transferred to outside air to cool the coolant. Operation of the first electric fan 25 facilitates the acceleration of heat transfer. The cooled coolant flows to the battery pack 38, the fourth straight-through valve 39, and the DC/DC converter (the DC/DC converter 40 is connected in parallel to the cooling pipeline of the battery pack 38; when the DC/DC converter 4 does not need to be cooled, the fourth straight-through valve 39 is closed), then flows to the port C of the four-way valve 16 and then flows out from the port B, and returns to the fourth electric water pump 32. In this way, a power-battery-pack room-temperature-cooling internal loop is formed and can effectively lower the temperature of the battery pack 38.

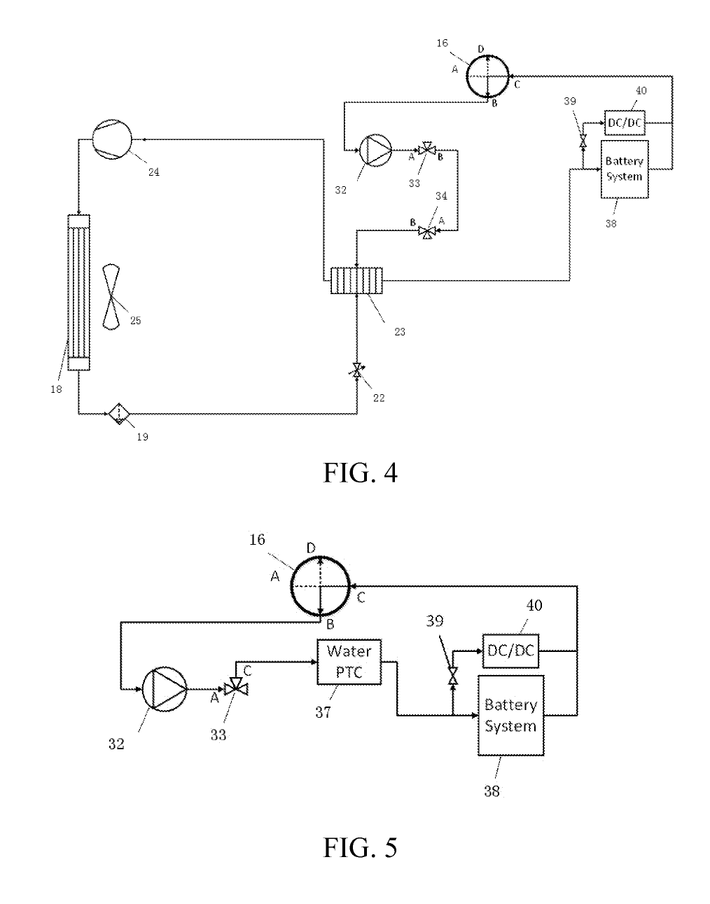

Referring to FIG. 4, when the temperature of outside air is excessively high or the heating power of the battery pack 38 is excessively high, the power-battery-pack room-temperature-cooling internal loop cannot satisfy a heat dissipation requirement of the battery pack 38. In this case, air-conditioning refrigeration is required to cool the battery pack 38. The condenser 18, the receiver drier 19, the second electronic expansion valve 22, the battery refrigerator 23, and the electric compressor 24 form a power-battery-pack air-conditioning-refrigeration external loop. The first electric fan 25 is configured to dissipate heat of the condenser 28. The fourth electric water pump 32, the third three-way valve 33, the fourth three-way valve 34, the battery refrigerator 23, the battery pack 38, the fourth straight-through valve 39, the DC/DC converter 40, and the four-way valve 16 are connected in series to form a power-battery-pack air-conditioning-refrigeration internal loop. A specific operating process, e.g., is: adjusting opening and closing of the second electronic expansion valve 22; turning on the electric compressor 24, the first electric fan 25, and the fourth electric water pump 32 such that a refrigerant in the power-battery-pack air-conditioning-refrigeration external loop sequentially flows through the electric compressor 24, the condenser 18, the receiver drier 19, the second electronic expansion valve 22, and a pipeline on a refrigerant side of the battery refrigerator 23, and then returns to the electric compressor 24. A coolant in the cooling pipeline inside the battery pack is driven by the fourth electric water pump 32, first flows to the inlet A of the third three-way valve 33, then flows out from the outlet B, then flows through an inlet A and an outlet B of the fourth three-way valve 34, and then flows to a pipeline on a coolant side of the battery refrigerator 23. Heat of the coolant is transferred to the refrigerant and then is rapidly cooled. The coolant then flows to the battery pack 38, the fourth straight-through valve 39, and the DC/DC converter (the DC/DC converter 40 is connected in parallel to the cooling pipeline of the battery pack 38; usually, the heating power of the DC/DC converter during operation is relatively low; when the DC/DC converter 40 does not need to be cooled, the fourth straight-through valve 39 is closed), then flows to the port C of the four-way valve 16 and then flows out from the port B, and returns to the fourth electric water pump 32. In this way, the temperature of the battery pack 38 can be rapidly lowered.

Referring to FIG. 5, when the electric vehicle is parked and being charged, if the temperature of the battery pack 38 is relatively low (for a lithium ion battery, when the temperature of the lithium ion battery is below 0° C., the temperature is usually considered relatively low), the battery pack 38 may not be rapidly charged. Therefore, the battery pack 38 needs to be preheated for faster charging. The coolant is driven by the fourth electric water pump 32, first flows to the inlet A of the third three-way valve 33 and then flows out from the outlet C, then flows through the second PTC heater 37 (in this case, the second PTC heater 37 is set in operation; usually, for prolonging the service life of the battery and promoting safety, the temperature of the coolant at an outlet of the second PTC heater 37 should not exceed 50° C.), and then flows to the cooling pipeline inside the battery pack 38, the fourth straight-through valve 39, and the DC/DC converter (the DC/DC converter 40 is connected in parallel to the cooling pipeline of the battery pack 38; when the DC/DC converter 40 does not need to be cooled, the fourth straight-through valve 39 is closed). Heat of the coolant is transferred to the battery pack 38 to heat the battery pack 38. The coolant then flows to the port C of the four-way valve 16 and flows out from the port B, and eventually returns to the electric water pump 32. In this way, a power-battery-pack low-temperature-heating internal loop is formed provide heating to the battery pack 38 in a low temperature environment.

### Example 3

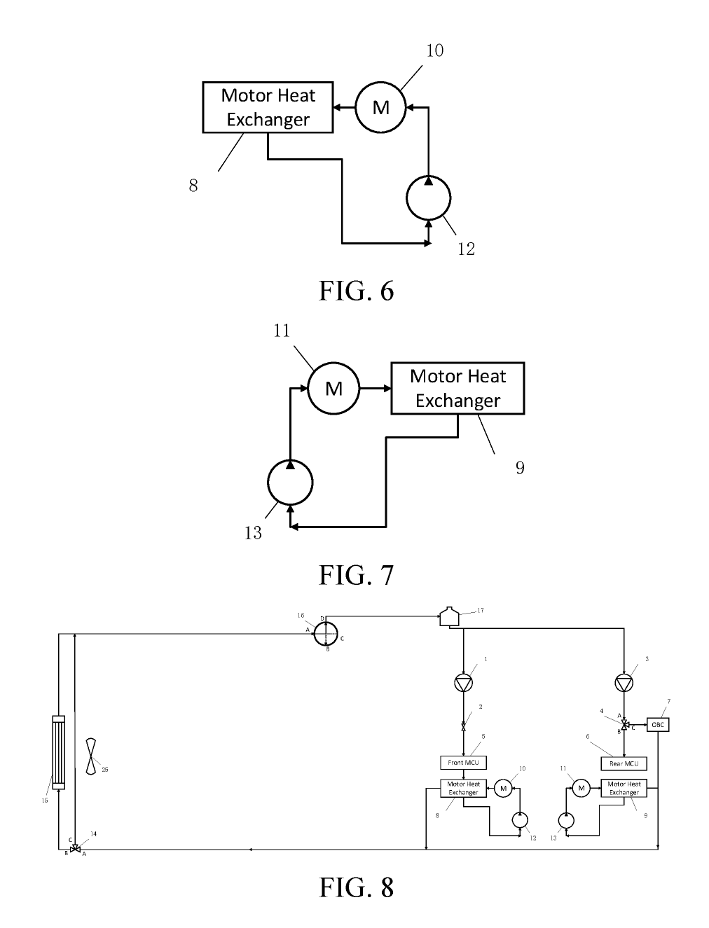

Referring to FIG. 6 and FIG. 7, the first electric oil pump 12, the first drive motor 10, and the first heat exchanger 8 are connected in series to form a first drive-motor oil-cooling loop. The second electric oil pump 13, the second drive motor 11, and the second heat exchanger 9 are connected to form a second drive-motor oil-cooling loop. The drive-motor oil-cooling loops are advantageous over a conventional motor liquid-cooling loop because insulating and thermally conductive oil may enter the drive motor, directly cool a rotor of the motor to provide a better cooling performance.

Referring to FIG. 8, the first electric water pump 1, the first straight-through valve 2, the first motor control unit 5, the first heat exchanger 8, the second electric water pump 3, the first three-way valve 4, the second motor control unit 6, the second heat exchanger 9, the on-board charger 7, the second three-way valve 14, the motor radiator 15, the first electric fan 25, the four-way valve 16, and the expansion tank 17 may form an electric-drive-module cooling loop of a four-wheel-drive electric vehicle.

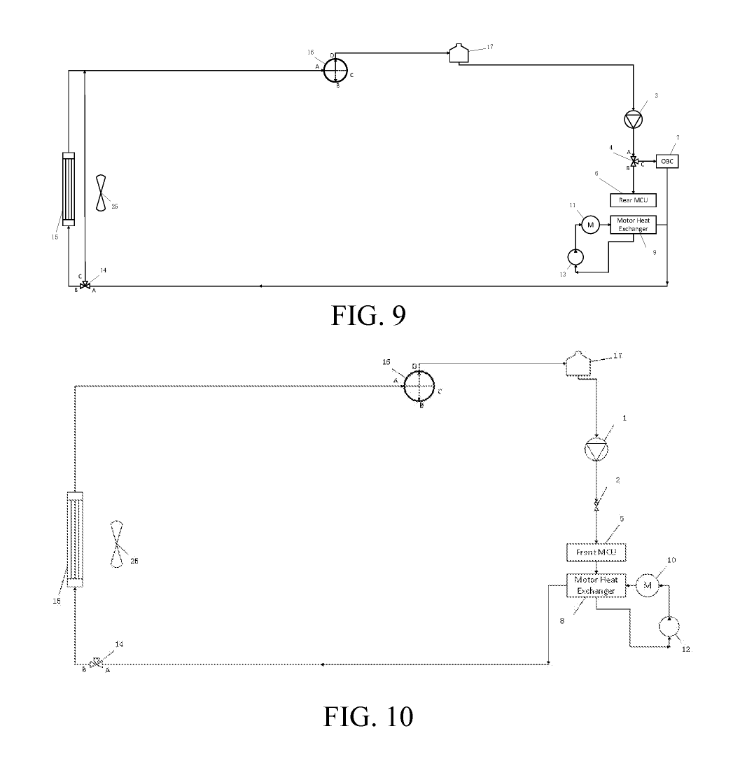

Referring to FIG. 9, for a two-wheel-drive electric vehicle, the electric-drive module of the electric vehicle may include only one drive motor, one motor control unit, and one on-board charger.

Referring to FIG. 10, when the electric vehicle is in normal operation, an electric-drive module component (a high-power component such as the drive motor and a motor control unit) of the electric vehicle usually needs to be cooled. When the electric vehicle is driven by the first front drive motor alone, thermally conductive oil of the drive-motor oil-cooling loop is driven by the first electric oil pump 12, flows inside the first drive motor 10, absorbs heat of the first front drive motor 10, then flows through a pipeline on an oil side of the first heat exchanger 8, transfers the heat to a housing of the first heat exchanger 8, and then returns to the first electric oil pump 12. In this way, an oil cooling loop of the first drive motor is formed. In the electric-drive-module cooling loop, the coolant is driven by the first electric water pump 1, flows through the first straight-through valve 2, and flows to the first motor control unit 5. Heat is transferred from the first motor control unit 5 to the coolant. The coolant then flows to the first heat exchanger 8 and absorbs the heat that is transferred by the thermally conductive oil to the housing of the heat exchanger, then flows to an inlet A of the second three-way valve 14 and flows out from an outlet B, and then flows to the motor radiator 15. Operation of the first electric fan 25 can facilitate transferring of heat in the coolant inside the motor radiator to outside air, and the temperature of the coolant is thus lowered. The coolant then flows from a port A of the four-way valve 16 and then flows out from a port D, passes through the expansion tank 17, and returns to the first electric water pump 1.

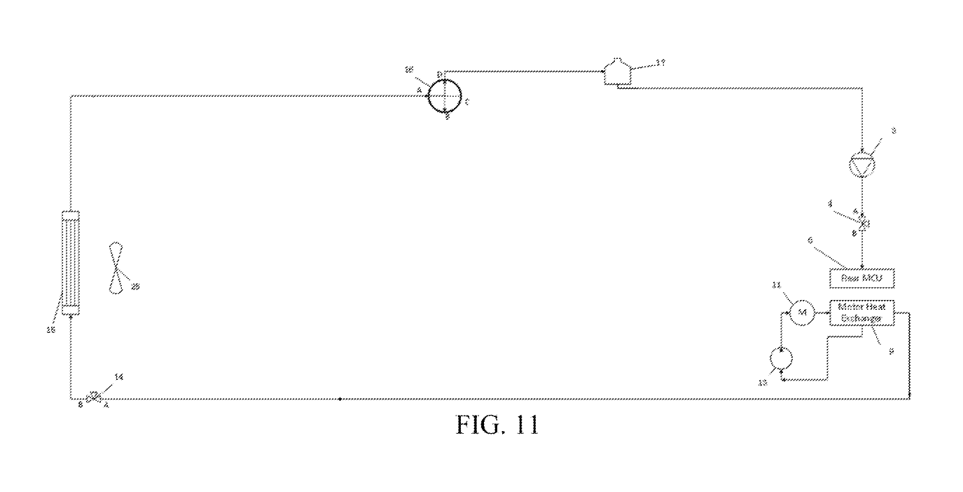

Referring to FIG. 11, when the electric vehicle is driven by a second rear drive motor alone, the thermally conductive oil in the drive-motor oil-cooling loop is driven by the second electric oil pump 13, flows inside the second drive motor 11, absorbs heat of the second drive motor 11, then flows through a pipeline on an oil side of the second heat exchanger 9, transfers the heat to a housing of the second heat exchanger 9, and then returns to the second electric oil pump 13. In this way, an oil cooling loop of the second drive motor is formed. In the electric-drive-module cooling loop, the coolant is driven by the second electric water pump 3, flows from an inlet A of the first three-way valve 4 and then flows out from an outlet B, and flows to the second motor control unit 6. Heat is transferred from the second motor control unit 6 to the coolant. The coolant then flows to the second heat exchanger 9, absorbs the heat that is transferred by the thermally conductive oil to the housing of the heat exchanger, then flows to the inlet A of the second three-way valve 14 and then flows out from the outlet B, and then flows to the motor radiator 15. Operation of the first electric fan 25 can facilitate transferring heat in the coolant inside the motor radiator to outside air, and the temperature of the coolant is thus lowered. The coolant then flows to the port A of the four-way valve 16 and then flows out from the port D, passes through the expansion tank 17, and returns to the second electric water pump 3.

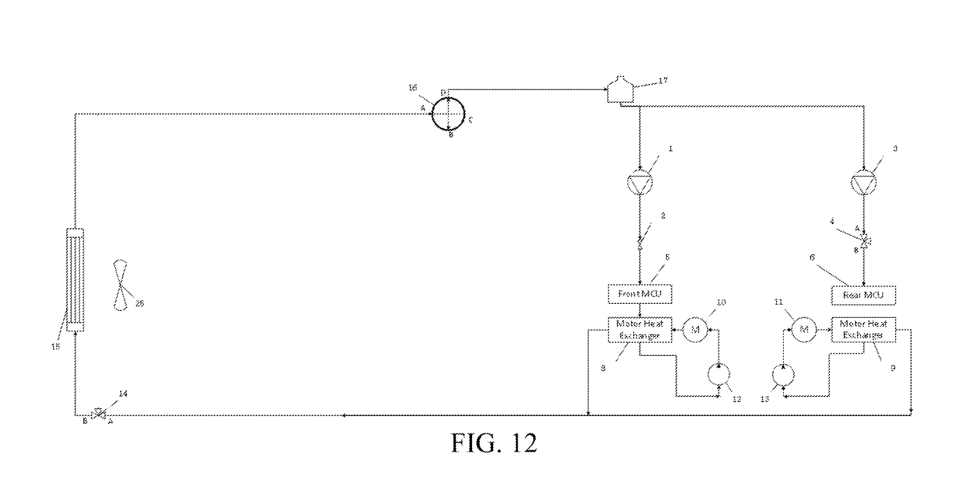

When the four-wheel-drive electric vehicle is driven by both the first (front) drive motor and the second (rear) drive motor of the electric vehicle, and referring to FIG. 12 for the drive-motor oil-cooling loops of the front drive motor and the rear drive motor and for the cooling system loop of the electric-drive module.

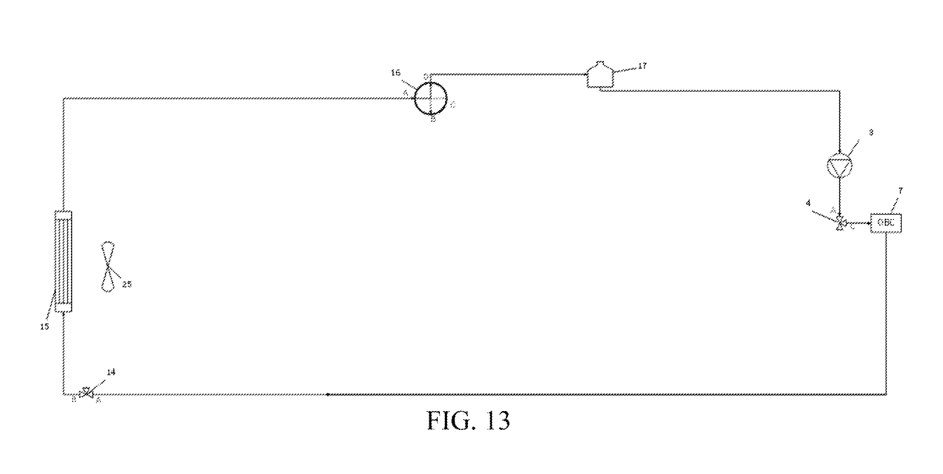

Referring to FIG. 13, when the electric vehicle is being charged under alternating-current, the coolant is driven by the second electric water pump 3, flows to the inlet A of the first three-way valve 4 and then flows out from an outlet C, flows through the on-board charger 7, absorbs heat of the on-board charger 7, then flows to the inlet A of the second three-way valve 14 and then flows out from the outlet B, and then flows to the motor radiator 15. Operation of the first electric fan 25 can facilitate transferring heat in the coolant inside the motor radiator to outside air, and the temperature of the coolant is thus lowered. The coolant then flows to the port A of the four-way valve 16 and then flows out from the port D, passes through the expansion tank 17, and returns to the second electric water pump 3.

### Example 4

Generally, the battery pack and the electric-drive module are in a parallel and independent operation configuration with no heat transfer between them. However, in some cases, the battery pack and the electric-drive module may be switched to operate in a serial configuration and heat may be transferred between them. The switching between the serial configuration and the parallel configuration may be switched by controlling the four-way valve 16. When the port A and the port D of the four-way valve 16 above are connected and the port B and the port C are connected, the battery pack and the electric-drive module are in a parallel configuration. When the port A and the port B of the four-way valve 16 are connected and the port C and the port D are connected, the battery pack and the electric-drive module are in a serial configuration.

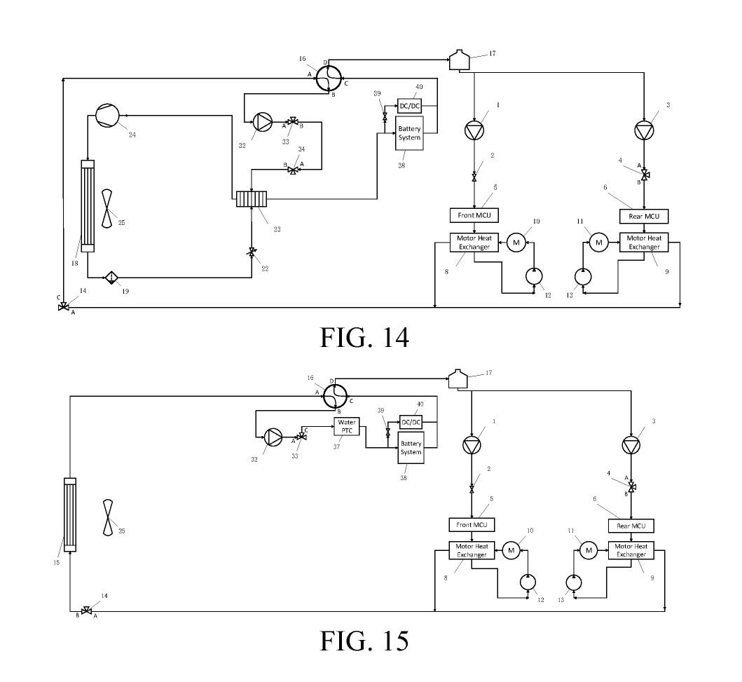

Referring to FIG. 14, when the temperature of a drive motor is excessively high, the electric-drive-module cooling loop alone may not satisfy a cooling requirement of the drive motor. In this case, air-conditioning refrigeration needs to be used to cool the drive motor. In one implementation, the second electronic expansion valve 22 is opened; the electric compressor 24 and the first electric fan 25 are turned on; a refrigerant flows through a pipeline on a refrigerant side of the battery refrigerator 23; the port A and the port B of the four-way valve 16 are controlled to be connected and the port C and the port D of the four-way valve 16 are controlled to be connected; the first electric water pump 1, the second electric water pump 3, and the fourth electric water pump 32 are turned on; and the first electric oil pump 12 and the second electric oil pump 13 are turned on at the same time. A coolant in the electric-drive-module cooling loop is driven by the first electric water pump 1 and the second electric water pump 3, sequentially flows through the first straight-through valve 2 and an inlet A and an outlet B of the first three-way valve 4, the first motor control unit 5, the second motor control unit 6, the first heat exchanger 8, the second heat exchanger 9, an inlet A and an outlet C of the second three-way valve 14, the port A and the port B of the four-way valve 16, the fourth electric water pump 32, an inlet A and an outlet B of the third three-way valve 33, an inlet A and an outlet B of the fourth three-way valve 34, a pipeline on a coolant side of the battery refrigerator 23 (heat of the coolant is transferred to the air-conditioning refrigerant flowing through the battery refrigerator 23), the battery pack 38, the fourth straight-through valve 39, the DC/DC converter 40 (the DC/DC converter is connected in parallel to a cooling pipeline of the battery pack; when the DC/DC converter 40 does not need to be cooled, the fourth straight-through valve 39 is closed), the port C and the port D of the four-way valve 16, and the expansion tank 17, and eventually returns to the first electric water pump 1 and the second electric water pump 3. The cooling loop may satisfy cooling requirements of the electric vehicle at a maximum speed and in extreme working conditions.

### Example 5

When an electric vehicle is in normally operation, if the temperature of a battery pack 38 is relatively low, the discharging performance of battery pack 38 is compromised. Thus, the full-charge range of the vehicle is reduced, and the battery pack 38 needs to be heated. To reduce vehicle energy consumption, waste heat generated by the electric-drive module including the drive motor and the motor control unit may be fully utilized to heat the battery pack 38. In this case, the power-battery-pack cooling loop may be connected in series with the electric-drive-module cooling loop.

Referring to FIG. 15, the port A and the port B of a four-way valve 16 are controlled to be connected, and the port C and the port D of the four-way valve 16 are controlled to be connected. The first electric water pump 1, the second electric water pump 3, and the fourth electric water pump 32 are turned on, and the first electric oil pump 12 and the second electric oil pump 13 are turned on at the same time. A coolant inside the electric-drive-module cooling loop flows out from an outlet of the motor radiator 15 and flows to the power-battery-pack cooling loop through the port A and the port B of the four-way valve 16. In this case, the temperature of the coolant flowing out from the port B of the four-way valve needs to be monitored. If the temperature of the coolant is not higher than an upper limit value representing a preset heating temperature of the battery pack 38 (the upper limit of the preset heating temperature of the battery pack is usually set to 50° C.), the coolant is then allowed to pass through the fourth electric water pump 32, flow to an inlet A of the third three-way valve 33, flow out from an outlet C, then flow to the second PTC heater 37 (in this case, the second PTC heater 37 is not in operation; if waste heat of the electric-drive module cannot satisfy a heating requirement of the battery pack, the second PTC heater 37 is turned on to assist heating), then flow to the battery pack 38, the fourth straight-through valve 39, and the DC/DC converter 40 (the DC/DC converter is connected in parallel to a cooling pipeline of the battery pack; when the DC/DC converter 40 does not need to be heated, the fourth straight-through valve 39 is closed), then pass through the port C and the port D of the four-way valve 16, flow to the expansion tank 17, and return to the electric-drive-module cooling loop.

Referring to FIG. 16, if the temperature of the coolant flowing out from the port B of the four-way valve is higher than the upper limit value of the preset heating temperature of the battery pack, the coolant is allowed to pass through the fourth electric water pump 32, flow to the inlet A of the third three-way valve 33, flow out from the outlet B, then flow to an inlet A of the fourth three-way valve 34 and flows out from an outlet C, and enter the battery radiator 35 (operation of the second electric fan 36 can facilitate transferring heat in the coolant to outside air), so that the temperature of the coolant drops below the upper limit value of the preset heating temperature of the battery pack before the coolant flows to the battery pack 38.

### Example 6

When an electric vehicle is being charged under an alternating-current, if the battery pack 38 or the DC/DC converter 40 and the on-board charger 7 both need to be cooled, the power-battery-pack cooling loop may be connected in series to the electric-drive-module cooling loop, so that the power-battery-pack cooling loop and the electric-drive-module cooling loop share the battery radiator 35 and the second electric fan 36, thereby facilitating heat transfer between the two loops and reducing energy consumption.

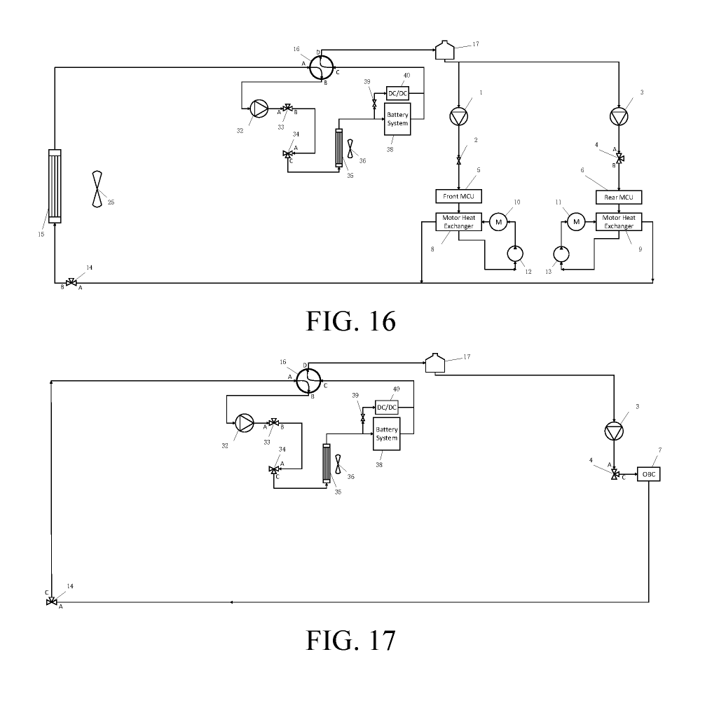

Referring to FIG. 17, the second electric water pump 3 and the fourth electric water pump 32 are turned on at the same time. A coolant flows to the second electric water pump 3 from the expansion tank 17, flows to the inlet A of the first three-way valve 4 and flows out from the outlet C, then flows to the cooling pipeline inside the on-board charger 7, absorbs heat of the on-board charger 7, then flows to the inlet A of the second three-way valve 14 and flows out from the outlet C, flows through the port A and the port B of the four-way valve 16, enters the fourth electric water pump 32, then flows to the inlet A of the third three-way valve 33 and flows out from the outlet B, then flows to the inlet A of the fourth three-way valve 34 and flows out from the outlet C, enters the battery radiator 35 (the size of the battery radiator 35 is usually smaller than that of the motor radiator 15; therefore, a heat dissipation capability of the battery radiator 35 is lower than that of the motor radiator 15; operation of the second electric fan 36 facilitates more rapid transfer of heat in the coolant in the battery radiator 35 to outside air), then enters the battery pack 38, the fourth straight-through valve 39, and the DC/DC converter 40 (the DC/DC converter is connected in parallel to a cooling pipeline of the battery pack; when the DC/DC converter 40 does not need to be cooled, the fourth straight-through valve 39 is closed), then flows out from the port C and the port D of the four-way valve 16, and returns to the expansion tank 17. In this way, the power-battery-pack cooling loop and the electric-drive-module cooling loop shares the battery radiator 35 for heat dissipation, thereby helping reducing energy consumption.

Referring to FIG. 18, when there is a relatively large amount of heat in the two cooling loops (the power battery-pack cooling loop and the electric-drive-module cooling loop) or the air temperature of an external environment is relatively high, the heat dissipation capability of the battery radiator 35 may be insufficient to satisfy a cooling requirement. In this case, a flowing path of the coolant can be changed, so that the two cooling loops share the motor radiator 15 for heat dissipation.

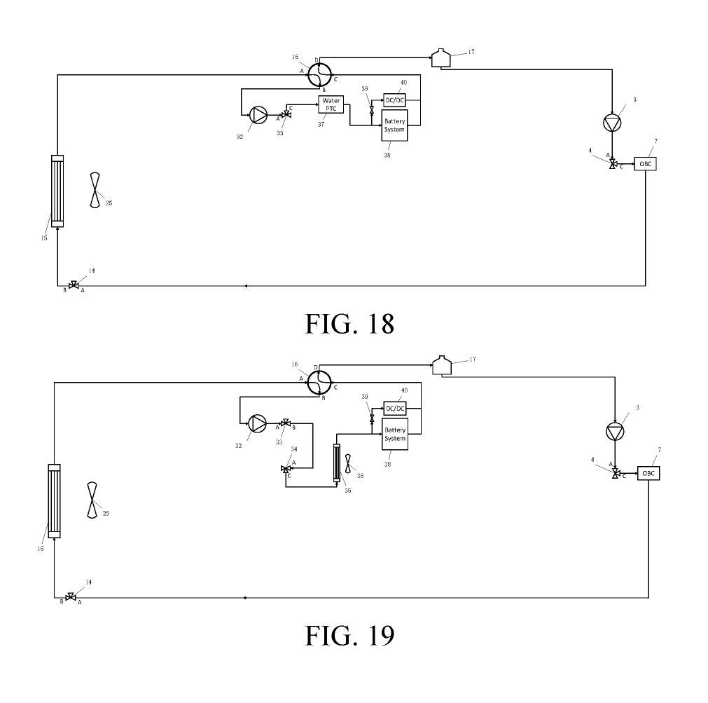

Referring to FIG. 19, when there is an even larger amount of heat in the two cooling loops or the air temperature of the external environment is even higher, the battery radiator 35 or the motor radiator 15 alone cannot satisfy a cooling requirement. The motor radiator 15 and the battery radiator 35 can be used at the same time for heat dissipation.

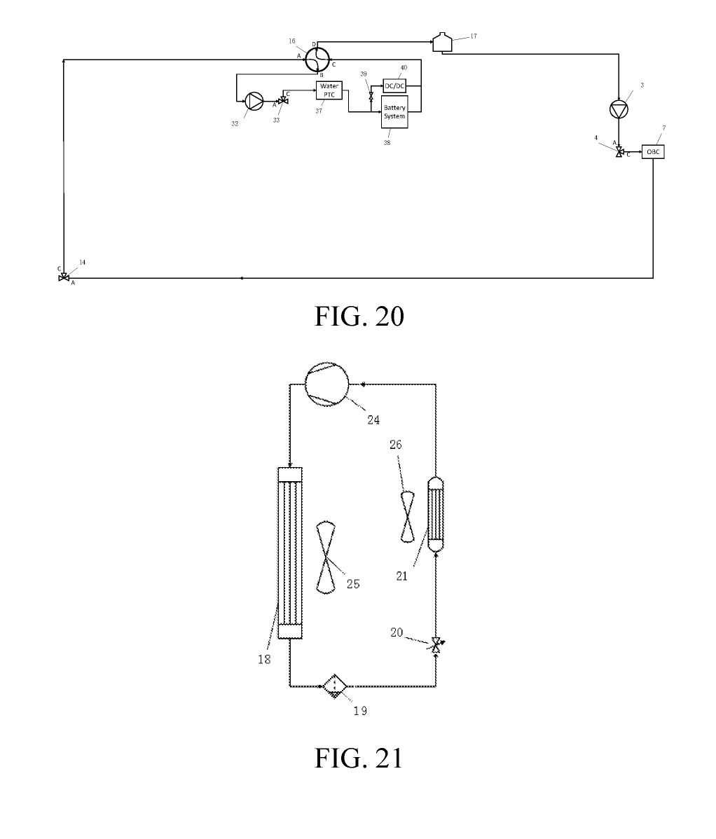

Referring to FIG. 20, when the electric vehicle is being charged under an alternating-current, and an external environment temperature may be very low (for example, when the environment temperature is below 0° C.). To prevent battery performance from degrading due to an excessively low temperature of the battery pack 38, the power-battery-pack cooling loop may be connected in series to the electric-drive-module cooling loop, and heat of the on-board charger 7 may be transferred to the battery pack. After flowing out from the fourth electric water pump 32, the coolant in the power-battery-pack cooling loop flows to the inlet A of the third three-way valve and flows out from the outlet C, flows through the second PTC heater 37 (in this case, the second PTC heater 37 is not in operation; if there is a relatively small amount of heat from the on-board charger 7 and the temperature of the battery pack cannot be prevented from dropping to an excessively low value, the second PTC heater 37 may be turned on to assist heating), then enters the battery pack 38, the fourth straight-through valve 39, and the DC/DC converter 40 (the DC/DC converter is connected in parallel to the cooling pipeline of the battery pack; when the DC/DC converter 40 does not need to be heated, the fourth straight-through valve 39 is closed), then flows through the port C and the port D of the four-way valve 16, passes through the expansion tank 17, and enters the electric-drive-module cooling loop. In this way, the heat of the on-board charger 7 is used to keep the temperature of the battery pack 38, to achieve an objective of reducing energy consumption.

### Example 7

Referring to FIG. 21, the condenser 18, the receiver drier 19, the first electronic expansion valve 20, the evaporator 21, and the electric compressor 24 are connected to form a passenger-compartment air-conditioning-refrigeration loop. The first electric fan 25 is configured to dissipate heat of the condenser 18, and the electric blower 26 drives an air flow through the evaporator 21. When the temperature of a passenger compartment is relatively high, opening and closing of the first electronic expansion valve 20 are regulated, the electric compressor 24, the first electric fan 25, and the electric blower 26 are set in operation, and a refrigerant in the air-conditioning refrigeration loop absorbs heat of the air flow through the evaporator 21, to rapidly cool the passenger compartment, providing comfort.

When the passenger compartment needs to be heated, heat generated by the electric-drive module component (such as the drive motors and the motor control units) may be used as a heat source, reducing energy consumption. When heat generated by the electric-drive module components is insufficient to satisfy a heating requirement, a PTC heater is used to assist supplying heat.

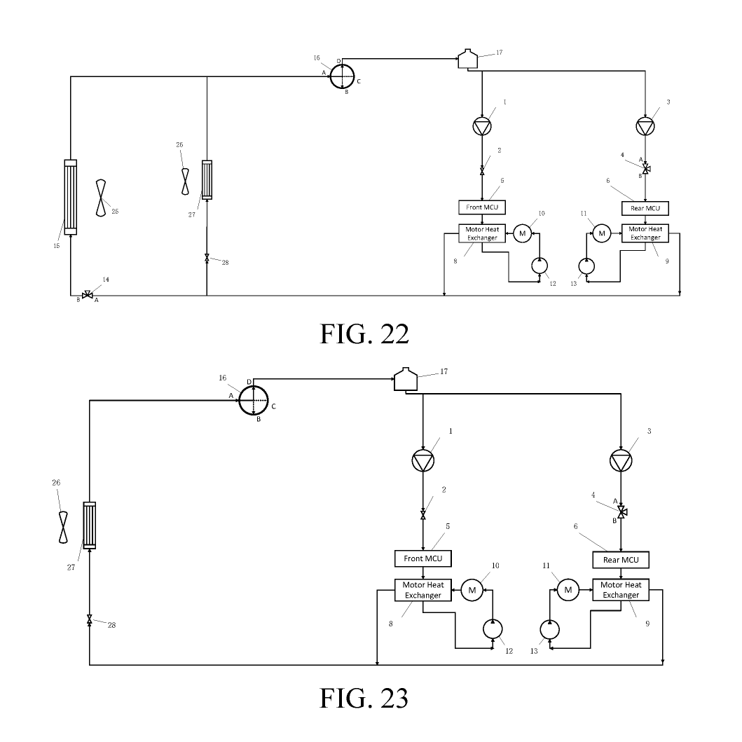

Referring to FIG. 22, when the heat generated by the electric-drive module components is excessive for the heating requirement of the passenger compartment, coolant in the expansion tank 17 is separately driven by the first electric water pump 1 and the second electric water pump 3, flows through the first straight-through valve 2 and the inlet A and the outlet B of the first three-way valve 4, flows to the first motor control unit 5 and the second motor control unit 6, absorbs heat generated by the first motor control unit 5 and the second motor control unit 6, then enters the first heat exchanger 8 and the second heat exchanger 9, and absorbs heat transferred from the first drive-motor oil-cooling loop and the second drive-motor oil-cooling loop. After the two streams of coolant converge, a portion of the converged coolant enters a pipeline on a coolant side of the heater core 27 through the open second straight-through valve 28 (operation of the electric blower 26 enables air to flow through a pipeline on an air side of the heater core 27 and absorb heat from the coolant; after being heated, air enters the passenger compartment for supplying heat). The other portion of the converged coolant flows to the motor radiator 15 (operation of the first electric fan 25 facilitate more rapid transfer of heat in the coolant to outside air), and the cooled coolant then passes through the port A and the port D of the four-way valve 16 and returns to the expansion tank 17. In this way, a passenger-compartment heating large circulation loop I is formed.

Referring to FIG. 23, when the heat generated by the electric-drive module components is just sufficient to meet the heating requirement of the passenger compartment, the second three-way valve 14 is closed, the coolant in the electric-drive-module cooling loop does not pass through the motor radiator 15 and only flows through the heater core 27 (air is driven by the electric blower 26 to flow through the pipeline on the air side of the heater core 27, absorbs heat from the coolant, and then enters the passenger compartment for supplying heat), then passes through the port A and the port D of the four-way valve 16, and returns to the expansion tank 17. In this way, a passenger-compartment heating large circulation loop II is formed.

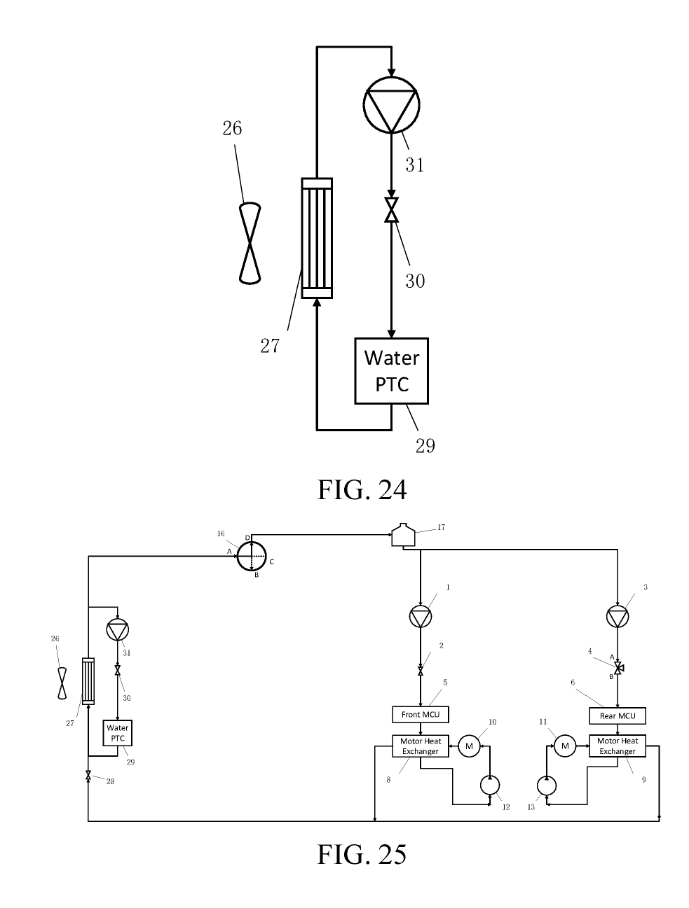

Referring to FIG. 24, when the electric-drive module components generate no heat, heating of the passenger compartment needs to depend completely on the PTC heater. In this case, the second straight-through valve 28 is closed, the third straight-through valve 30 is opened, and the coolant is driven by the third electric water pump 31, enters the first PTC heater 29 and is heated, then flows through the pipeline on the coolant side of the heater core 27, transfers heat of the coolant to a pipeline housing of the heater core 27 (the electric blower 26 drives air to flow through the pipeline on the air side of the heater core 27, absorbs heat from the coolant, and then enters the passenger compartment for supplying heat), and then returns to the third electric water pump 31. In this way, a passenger-compartment heating small circulation loop is formed.

Referring to FIG. 25, when the electric-drive module components generate heat but the generated heat is insufficient to meet the heating requirement of the passenger compartment, the PTC heater can be turned on at the same time to assist heating. The second straight-through valve 28 and the third straight-through valve 30 are opened, the first electric water pump 1, the second electric water pump 3, and the third electric water pump 31 are turned on. After completely flowing through the heater core 27, the coolant of the electric-drive-module cooling loop then passes through the port A and the port D of the four-way valve 16 and returns to the expansion tank 17, and the coolant of the passenger-compartment heating small circulation loop also flows through the heater core 27. In this way, the passenger-compartment heating large circulation loop and the passenger-compartment heating small circulation loop coexist and are both in operation.

### Example 8

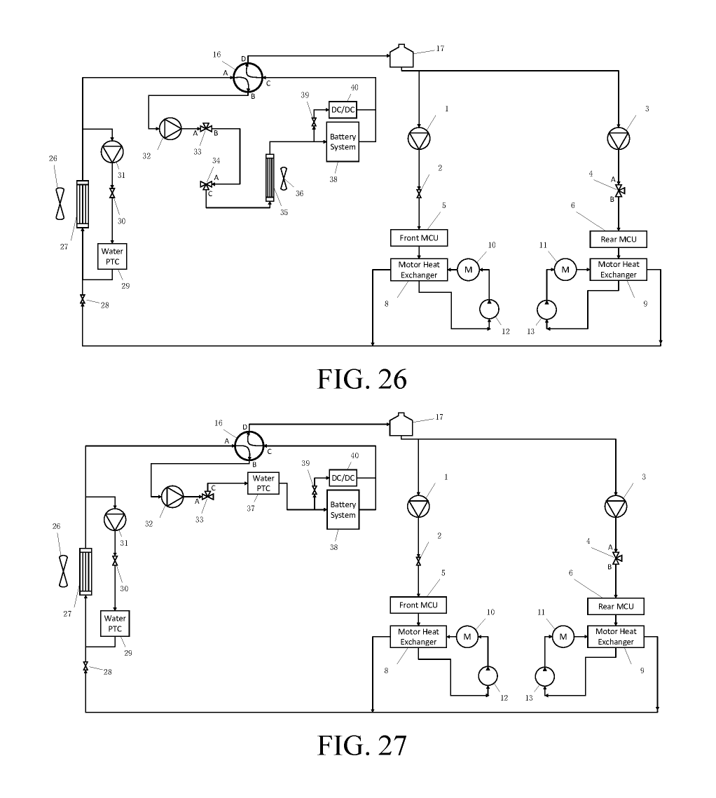

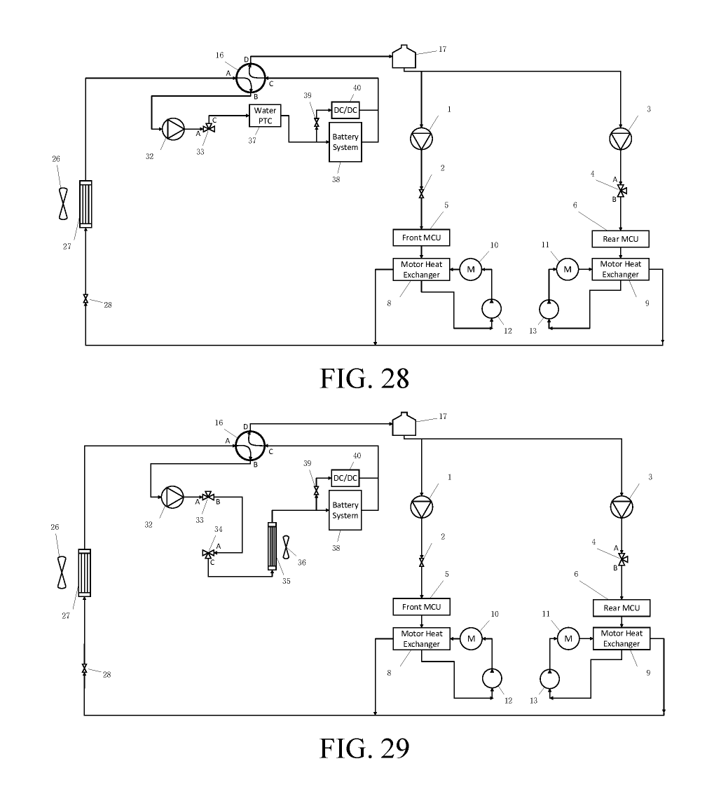

The foregoing multiple passenger-compartment heating circulation loops are independent from the power-battery-pack cooling loop without any heat transfer between the passenger-compartment heating circulation loops and the power-battery-pack cooling loop. However, when there are both a need for heating the passenger compartment and a need for heating the battery pack, the four-way valve 16 may be configured so that the port A and the port B of the four-way valve 16 are connected and the port C and the port D of the four-way valve 16 are connected. As such, the passenger-compartment heating loop may be connected in series to the power-battery-pack cooling loop, and heat generated by the electric-drive module components may be used to heat the passenger compartment and the battery pack 38. When the heat generated by the electric-drive module components is insufficient to satisfy both the heating need of the passenger compartment and the heating need of the battery pack, one or two PTC heaters may need to be turned on to assist heating. FIGS. 26-29 illustrates specific implementations.

As a person of ordinary skill in the art will readily appreciate that the description and the examples described above is meant as an illustration of the underlying principles of various implementations. This disclosure is not intended to limit the scope or application of the underlying principles in that the implementations are susceptible to modification, variation and change, without departing from the spirit of this disclosure, as defined in the following claims.

1. An intelligent multi-loop thermal management system for an electric vehicle, the system comprising:
components including a battery pack, an electric-drive module, an on-board charger, a DC/DC converter, a battery radiator, a battery refrigerator, a motor radiator, an electric water pump, an electric oil pump, an expansion tank, a PTC heater, a heat exchanger, an electric compressor, a condenser, an evaporator, a receiver drier, and a heater core; and
the electric-drive module having a drive motor and a motor control unit, wherein the components are thermally connected to each other by using a pipeline and a four-way valve, a three-way valve, a straight-through valve, and an electronic expansion valve that are disposed in the pipeline, to form a plurality of loops that separately performs thermal management and control the battery pack, the electric-drive module, and a passenger compartment air conditioner, the plurality of loops include:
a power-battery-pack temperature-equalization internal loop, a power-battery-pack room-temperature-cooling internal loop, a power-battery-pack air-conditioning-refrigeration external loop, a power-battery-pack air-conditioning-refrigeration internal loop, and a power-battery-pack low-temperature-heating internal loop each of which is configured to perform thermal management and control on the power battery pack;
a passenger-compartment refrigeration loop, a passenger-compartment heating large circulation loop, and a passenger-compartment heating small circulation loop each of which is configured to perform thermal management and control on the passenger compartment air conditioner; and
an electric-drive-module cooling loop and a drive-motor oil-cooling loop configured to perform thermal management and control on the electric-drive module.

2. The thermal management system of an intelligent multi-loop electric vehicle according to claim 1, wherein:
the power-battery-pack temperature-equalization internal loop is formed by connecting the battery pack, the four-way valve, the electric water pump, the three-way valve, and the PTC heater in series when the PTC heater is not operating;
the power-battery-pack low-temperature-heating internal loop is formed by connecting the battery pack, the four-way valve, the electric water pump, the three-way valve, and the PTC heater in series when the PTC heater is operating;
the power-battery-pack room-temperature-cooling internal loop is formed by connecting the battery pack, the four-way valve, the electric water pump, the three-way valve, a second three way valve, and the battery radiator in series;
the power-battery-pack air-conditioning-refrigeration external loop is formed by connecting the electric compressor, the condenser, the receiver drier, the electronic expansion valve, and the battery refrigerator in series; and
the power-battery-pack air-conditioning-refrigeration internal loop is formed by connecting the battery pack, the four-way valve, the electric water pump, the three-way valve, and the battery refrigerator in series.

3. The thermal management system of an intelligent multi-loop electric vehicle according to claim 1, wherein
the electric-drive-module cooling loop is formed by connecting the electric water pump, the straight-through valve, the motor control unit, the heat exchanger, the three-way valve, the motor radiator, the four-way valve, and the expansion tank in series; and
the drive-motor oil-cooling loop is formed by connecting the drive motor, the heat exchanger, and the electric oil pump in series.

4. The thermal management system of an intelligent multi-loop electric vehicle according to claim 3, wherein:
the passenger-compartment refrigeration loop is formed by connecting the electric compressor, the condenser, the receiver drier, the electronic expansion valve, and the evaporator in series;
the passenger-compartment heating large circulation loop is formed by connecting the electric-drive-module cooling loop, the straight-through valve, and the heater core in series; and
the passenger-compartment heating small circulation loop is formed by connecting the heater core, the electric water pump, the straight-through valve, and the PTC heater in series.

5. The thermal management system of an intelligent multi-loop electric vehicle according to claim 1, wherein the electric water pump, the electric oil pump, the straight-through valve, the three-way valve, the four-way valve, and the electronic expansion valve are connected to a vehicle control unit, and the battery pack is connected in series or in parallel to the electric-drive module by controlling an opening degree of the four-way valve.

6. The thermal management system of an intelligent multi-loop electric vehicle according to claim 1, wherein in the thermal management system, temperature sensors are provided inside the battery pack, the drive motor, the motor control unit, the DC/DC converter, and the on-board charger, wherein the temperature sensors are connected to a vehicle control unit and output collected temperatures to the vehicle control unit.

7. The thermal management system of an intelligent multi-loop electric vehicle according to claim 1, wherein the DC/DC converter is connected in series to the straight-through valve and is connected in parallel to the battery pack, and the on-board charger is connected in parallel to the electric-drive module.

8. The thermal management system of an intelligent multi-loop electric vehicle according to claim 1, wherein:
the drive motor comprises a first drive motor and a second drive motor, the motor control unit comprises a first motor control unit and a second motor control unit;
the electric water pump comprises a first electric water pump, a second electric water pump, a third electric water pump, and a fourth electric water pump;
the electric oil pump comprises a first electric oil pump and a second electric oil pump;
the PTC heater comprises a first PTC heater and a second PTC heater;
the heat exchanger comprises a first heat exchanger and a second heat exchanger;
the electronic expansion valve comprises a first electronic expansion valve and a second electronic expansion valve;
the three-way valve comprises a first three-way valve, a second three-way valve, a third three-way valve, and a fourth three-way valve; and
the straight-through valve comprises a first straight-through valve, a second straight-through valve, a third straight-through valve, and a fourth straight-through valve.

9. The thermal management system of an intelligent multi-loop electric vehicle according to claim 8, wherein the first electric water pump, the first motor control unit, and the first heat exchanger are connected in series and are connected in parallel to the second electric water pump, the second motor control unit, and the second heat exchanger that are connected in series.

10. The thermal management system of an intelligent multi-loop electric vehicle according to claim 1, wherein the thermal management system further comprises an electric fan adjacent to the motor radiator and the battery radiator and configured to assist heat dissipation.

11. The thermal management system of an intelligent multi-loop electric vehicle according to claim 10, wherein the electric fan is connected to a vehicle control unit, the electric fan is provided adjacent to the motor radiator and the battery radiator, the electric fan comprises a first electric fan and a second electric fan, and in the thermal management system, an electric blower connected to the vehicle control unit is provided adjacent to the evaporator.
